(19) United States
(12) Patent Application Publication
(10) Pub. No.: US 2025/0023653 A1
(43) Pub. Date: Jan. 16, 2025

(54) CYCLE SYNCHRONIZATION METHOD, SYSTEM, AND APPARATUS, AND ELECTRONIC DEVICE

(71) Applicant: NEW H3C TECHNOLOGIES CO., LTD., Zhejiang (CN)

(72) Inventor: Daorong GUO, Beijing (CN)

(73) Assignee: NEW H3C TECHNOLOGIES CO., LTD., Zhejiang (CN)

(21) Appl. No.: 18/713,824

(22) PCT Filed: Jul. 29, 2022
(86) PCT No.: PCT/CN2022/109171

§ 371 Date: May 28, 2024

(51) Int. Cl. H04J 3/06; H04L 47/50; H04W 56/00

(52) U.S. Cl. CPC H04J 3/0658; H04L 47/50; H04W 56/0015

(57) ABSTRACT

Embodiments of the present disclosure provide cycle synchronization methods, systems and apparatuses, and electronic devices. In an embodiment, without depending on strict clock synchronization of the transmission nodes at both ends, it is simply required to adjust a width of a scheduling cycle for packet queue scheduling in the transmission node at one end to enable the error between the adjusted width of the scheduling cycle and a width of a scheduling cycle for packet queue scheduling in the other transmission node to be within a preset synchronization range, so as to achieve weak synchronization of the transmission nodes at both ends in deterministic flow transmission, ensuring normal forwarding of the deterministic flow.

### TECHNICAL FIELD

The present disclosure relates to the field of network communication technologies, and in particular to cycle synchronization methods, systems, apparatuses and electronic devices.

### BACKGROUND

In the current deterministic flow transmission applications, clock synchronization between transmission nodes at both ends requires hardware-level support. For example, taking the clock synchronization to be achieved between transmission nodes at both ends of the 5G system (5GS) as an example, any one of the transmission nodes at both ends of the 5GS, such as, a Network-side TSN (Time-Sensitive Networking) translator (NW-TT) or a Device-side TSN translator (DS-TT), requires hardware-level support in achieving clock synchronization. For most of the low-cost products, it is difficult for the hardware level to support clock synchronization.

### SUMMARY

Embodiments of the present disclosure provide cycle synchronization methods, systems, apparatuses, and electronic devices, so as to achieve synchronization of scheduling cycles for packet queue scheduling in the transmission nodes at both ends while maintaining mutual independence in clock domains of the transmission nodes at both ends.

An embodiment of the present disclosure provides a cycle synchronization method, which is applied to a first transmission node. The first transmission node is coupled to a second transmission node; a first clock domain of the first transmission node is different from a second clock domain of the second transmission node; a network system between the first transmission node and the second transmission node is coupled to the first transmission node through a first intermediate device, and is coupled to the second transmission node through a second intermediate device; and the first intermediate device and the second intermediate device have a same third clock domain in the network system. The method includes:
in response to detecting a packet transmission event, sending a first cycle synchronization information packet to the second transmission node at a time point t1[1] under the first clock domain, such that the second transmission node, upon determining that a width of a scheduling cycle for packet queue scheduling in the second transmission node needs to be adjusted based on the first cycle synchronization information packet, adjusts the width of the scheduling cycle, so as to enable an error between the adjusted width of the scheduling cycle and a width of a scheduling cycle for packet queue scheduling in the first transmission node to be within a preset synchronization range;

the first cycle synchronization information packet includes at least: a current cycle C1_1 of the first transmission node and first time information; where the current cycle is a scheduling cycle in which the first transmission node is currently located for packet queue scheduling, or the current cycle is a system cycle of the first transmission node; the first time information is a time point under the third clock domain, which is determined based on time information t3[1] under the third clock domain corresponding to the time point t1[1] in the first clock domain.

An embodiment of the present disclosure further provides a cycle synchronization method, which is applied to a second transmission node. The second transmission node is coupled to a first transmission node; a first clock domain of the first transmission node is different from a second clock domain of the second transmission node; a network system between the first transmission node and the second transmission node is coupled to the first transmission node through a first intermediate device, and is coupled to the second transmission node through a second intermediate device; and the first intermediate device and the second intermediate device have a same third clock domain in the network system. The method includes:
receiving a first cycle synchronization information packet from the first transmission node at a time point t2[1] under the second clock domain and determining a current cycle C2_1 of the second transmission node;
based on a cycle C1_1 and first time information included in the first cycle synchronization information packet, determining a cycle C1_2 in which the first transmission node is currently located at the time point t2[1];
based on the C2_1 and C1_2, and C2_0 and C1_0 both determined by the second transmission node upon receiving a second cycle synchronization information packet previously, determining whether to adjust a width of a scheduling cycle for packet queue scheduling in the second transmission node; if yes, adjusting the width of the scheduling cycle for packet queue scheduling in the second transmission node to enable an error between the adjusted width of the scheduling cycle and a width of a scheduling cycle for packet queue scheduling in the first transmission node to be within a preset synchronization range, where C2_0 represents a current cycle in which the second transmission node receives the second cycle synchronization information packet, and C1_0 represents a cycle in which the first transmission node is located when the second transmission node receives the second cycle synchronization information packet.

An embodiment of the present disclosure provides a cycle synchronization system, including a first transmission node and a second transmission node, where a first clock domain of the first transmission node is different from a second clock domain of the second transmission node; a network system between the first transmission node and the second transmission node is coupled to the first transmission node through a first intermediate device, and is coupled to the second transmission node through a second intermediate device; the first intermediate device and the second intermediate device have a same third clock domain in the network system;
the first transmission node performs operations in the above first method;
the second transmission node performs operations in the above second method.

An embodiment of the present disclosure provides a cycle synchronization apparatus, which is applied to a first transmission node. The first transmission node is coupled to a second transmission node; a first clock domain of the first transmission node is different from a second clock domain of the second transmission node; a network system between the first transmission node and the second transmission node is coupled to the first transmission node through a first intermediate device, and is coupled to the second transmission node through a second intermediate device; the first intermediate device and the second intermediate device have a same third clock domain in the network system. The apparatus includes:
a detecting unit, configured to detect a packet transmission event;
a sending unit, configured to, when the detecting unit detects the packet transmission event, send a first cycle synchronization information packet to the second transmission node at a time point t1[1] under the first clock domain, such that the second transmission node, upon determining that a width of a scheduling cycle for packet queue scheduling in the second transmission node needs to be adjusted based on the first cycle synchronization information packet, adjust the width of the scheduling cycle, so as to enable an error between the adjusted width of the scheduling cycle and a width of a scheduling cycle for packet queue scheduling in the first transmission node to be within a preset synchronization range;
the first cycle synchronization information packet includes at least: a current cycle C1_1 of the first transmission node and first time information; wherein the current cycle is a scheduling cycle in which the first transmission node is currently located for packet queue scheduling, or the current cycle is a system cycle of the first transmission node; the first time information is a time point under the third clock domain, which is determined based on time information t3[1] under the third clock domain corresponding to the time point t1[1] in the first clock domain.

An embodiment of the present disclosure provides a cycle synchronization apparatus, which is applied to a second transmission node. The second transmission node is coupled to a first transmission node; a first clock domain of the first transmission node is different from a second clock domain of the second transmission node; a network system between the first transmission node and the second transmission node is coupled to the first transmission node through a first intermediate device, and is coupled to the second transmission node through a second intermediate device; and the first intermediate device and the second intermediate device have a same third clock domain in the network system. The apparatus includes:
a receiving unit, configured to receive a first cycle synchronization information packet from the first transmission node at a time point t2[1] under the second clock domain and determine a current cycle C2_1 of the second transmission node;
a determining unit, configured to, based on a cycle C1_1 and first time information included in the first cycle synchronization information packet, determine a cycle C1_2 in which the first transmission node is currently located at the time point t2[1];
an adjusting unit, configured to, based on the C2_1 and C1_2, and C2_0 and C1_0 both determined by the second transmission node upon receiving a second cycle synchronization information packet previously, determine whether to adjust a width of a scheduling cycle for packet queue scheduling in the second transmission node; if yes, adjust the width of the scheduling cycle for packet queue scheduling in the second transmission node to enable the an error between the adjusted width of the scheduling cycle and a width of a scheduling cycle for packet queue scheduling in the first transmission node to be within a preset synchronization range, where C2_0 represents a current cycle in which the second transmission node receives the second cycle synchronization information packet, and C1_0 represents a cycle in which the first transmission node is located when the second transmission node receives the second cycle synchronization information packet.

An embodiment of the present disclosure provides an electronic device, which includes a processor and a machine-readable storage medium; where,
the machine-readable storage medium stores machine executable instructions executable by the processor;
the processor is configured to execute the machine executable instructions to perform any one of the above methods.

An embodiment of the present disclosure provides a machine-readable storage medium, storing machine executable instructions executable by a processor; where,
the machine executable instructions are executed by the processor to perform any one of the above methods.

It can be seen from the above technical solutions, that in the embodiments of the present disclosure, without depending on strict clock synchronization of the transmission nodes at both ends, it is simply required to adjust a width of a scheduling cycle for packet queue scheduling in the transmission node at one end to enable the error between the adjusted width of the scheduling cycle and a width of a scheduling cycle for packet queue scheduling in the other transmission node to be a preset synchronization range, so as to achieve weak synchronization of the transmission nodes at both ends in deterministic flow transmission, ensuring normal forwarding of the deterministic flow.

### BRIEF DESCRIPTION OF DRAWINGS

The accompanying drawings, which are incorporated in and constitute a part of the present description, illustrate embodiments consistent with the present disclosure and serve to explain the principles of the present disclosure together with the description.

FIG. 1 is a flowchart illustrating a method according to embodiments of the present disclosure.

FIG. 2 is a flowchart illustrating another method according to embodiments of the present disclosure.

FIG. 3 is a schematic diagram illustrating a network according to embodiments of the present disclosure.

FIG. 4 is a schematic diagram illustrating a clock domain according to embodiments of the present disclosure.

FIG. 5 is a schematic diagram illustrating an implementation time sequence according to embodiments of the present disclosure.

FIG. 6 is a structural diagram illustrating an apparatus according to embodiments of the present disclosure.

FIG. 7 is a structural diagram illustrating another apparatus according to embodiments of the present disclosure.

FIG. 8 is a structural diagram illustrating an electronic device according to embodiments of the present disclosure.

### DETAILED DESCRIPTION

Exemplary embodiments will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The terms used in the present disclosure are used only for describing specific embodiments rather than limiting the present disclosure. The terms “a”, “the” and “said” in singular form in the present disclosure are also intended to include plural forms, unless otherwise clearly indicated in the context.

The methods provided by the embodiments of the present disclosure will be described below.

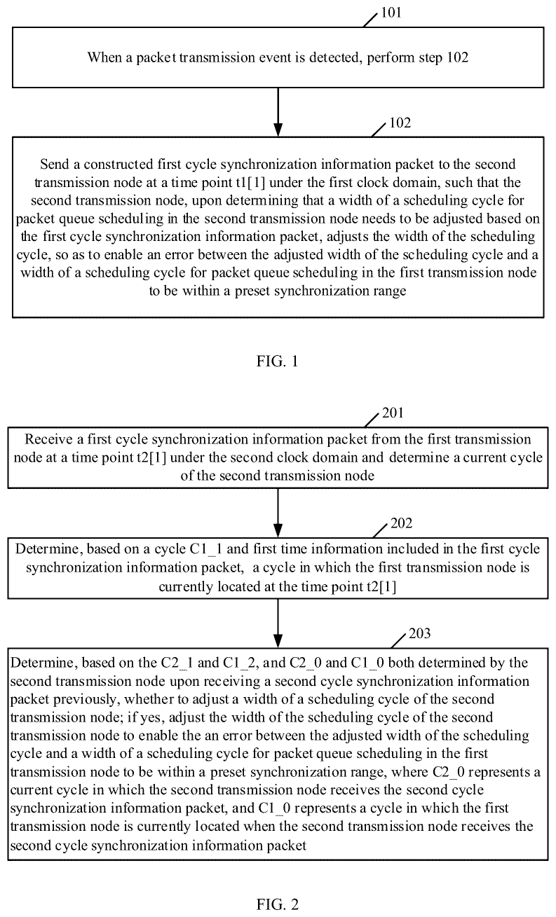

FIG. 1 is a flowchart illustrating a method according to embodiments of the present disclosure. The method is applied to a first transmission node which is coupled to a second transmission node. Herein, the first transmission node and the second transmission node are named only for ease of descriptions rather than for the purpose of limitation. With the first transmission node and the second transmission node as transmission node at both ends of 5GS, in this embodiment, one of the first transmission node and the second transmission node is Device-Side TSN Translator (DS-TT) and the other is a Network-Side TSN Translator (NW-TT), or the first transmission node and the second transmission node are two different DS-TTs or the like, which is not limited herein.

In this embodiment, a first clock domain of the first transmission node is different from a second clock domain of the second transmission node.

Furthermore, in this embodiment, there is a network system between the first transmission node and the second transmission node. For example, the network system can be a 5GS or another mobile system or the like, which is not limited herein. In this embodiment, the above network system is coupled to the first transmission node through a first intermediate device, and is coupled to the second transmission node through a second intermediate device, and the first intermediate device and the second intermediate device have a same third clock domain in the network system.

With the above network system as 5GS, it is found through researches on 5GS that a User Plane Function network element (UPF) and a User Equipment (UE) have a unified clock domain, i.e., 5GS clock domain (5GS Timer) in the 5GS, and the 5GS is coupled to the two transmission nodes respectively through the UPF and the UE serving as intermediate devices.

For example, when the first transmission node is an NW-TT and the second transmission node is a DS-TT, the 5GS is coupled to the NW-TT serving as the first transmission node through the UPF, and is coupled to the DS-TT serving as the second transmission node through the UE. At this time, the first intermediate device is the UPF, the second intermediate device is the UE, and the third clock domain is the 5GS clock domain.

Based on this, in this embodiment, the first transmission node may take time information of the third clock domain, for example, the 5GS clock domain, on the first intermediate device coupled hereto as reference, and the second transmission node take may take time information of the third clock domain, for example, the 5GS clock domain, on the second intermediate device coupled hereto as reference, and cycle synchronization of the first transmission node and the seconds transmission node is achieved macroscopically by interaction. Illustrative descriptions will be made below with the blocks in FIG. 1.

As shown in FIG. 1, the flow can include the following blocks.

At block 101, when a packet transmission event is detected, block 102 is performed.

In this embodiment, the packet transmission event can be implemented in many forms, for example, by arrival of packet transmission time (for example, arrival of a transmission cycle, or arrival of a packet transmission timing or the like) or external trigger or the like, which is not limited in this embodiment.

At block 102, a constructed first cycle synchronization information packet is sent to the second transmission node at a time point t[1] under the first clock domain, such that the second transmission node, upon determining that a width of a scheduling cycle for packet queue scheduling in the second transmission node needs to be adjusted based on the first cycle synchronization information packet, adjusts the width of the scheduling cycle, so as to enable an error between the adjusted width of the scheduling cycle and a width of a scheduling cycle for packet queue scheduling in the first transmission node to be within a preset synchronization range.

In this embodiment, the first cycle synchronization information packet includes at least: a current cycle (denoted as C1_1) of the first transmission node and first time information.

As an embodiment, the current cycle is a scheduling cycle in which the first transmission node is currently located for packet queue scheduling, for example, an i-th scheduling cycle. The packet queue herein is used to store packets for a deterministic flow.

As another embodiment, the current cycle is a system cycle in the first transmission node. In this embodiment, the system cycle refers to a total number of scheduling cycles experienced by the first transmission node, where the system cycle will be increased by a set value, for example, 1, for every one scheduling cycle experienced.

In this embodiment, the first time information is a time point under the third clock domain, which is determined based on time information (denoted as t3[1]) which is under the third clock domain and corresponds to the time point t1[1] in the first clock domain. t3[1] represents a time point under the third clock domain. Taking the third clock domain as 5GS clock domain in the 5GS as an example, the first time information can be a time point in the 5GS clock domain in the 5GS, which can be determined based on a 5GS time point in the 5GS corresponding to the time point t1[1].

As an embodiment, in this embodiment, considering a transmission delay (denoted as a) of time information between the first transmission node and the first intermediate device, the time information t3[1] under the third clock domain corresponding to the time point t1[1] in the first clock domain can be expressed in the following formula (1):

$$t 3 [ 1 ] = t3\_ 1 [ 0 ] + a + Δ t 1 \qquad ( 1 )$$

In the formula (1), t3_1[0] represents time information under the third clock domain obtained by the first transmission node at a time point t[0] under the first clock domain, in other words, the time information is sent at t3_1[0] under the third clock domain and obtained by the first transmission node at t[0]. As an embodiment, t3_1[0] represents a time point under the third clock domain. Taking the third clock domain as 5GS clock domain in the 5GS as an example, t3_1[0] can represent a time point under the 5GS clock domain in the 5GS. t3_1[0] is less than t3[1].

In the formula (1), Δt1 represents a time difference between the time point t1[1] and the time point t1[0].

Based on the above t3[1], as an embodiment, the first time information can be t3[1].

As another embodiment, in consideration of accuracy, the first time information can be a difference between t3[1] and t1_{CyclePast}. Herein, t1_{CyclePast} represents a difference between the time point t1[1] and a start moment of the current cycle.

Here, the flow shown in FIG. 1 is completed.

It can be seen from the flow shown in FIG. 1 that, in this embodiment, under the network system coupled to the first transmission node and the second transmission node, with the time information under the third clock domain, for example, the 5GS time information as reference, the first transmission node sends the first cycle synchronization information packet including at least the above cycle identifier C1_1 (for identifying the current cycle of the first transmission node) and the first time information (a time point under the third clock domain), such that the second transmission node, upon determining that the width of the scheduling cycle for packet queue scheduling in the second transmission node needs to be adjusted based on the first cycle synchronization information packet, adjusts the width of the scheduling cycle for packet queue scheduling in the second transmission node, so as to enable an error between the adjusted width of the scheduling cycle of the second transmission node and the width of the scheduling cycle for packet queue scheduling in the first transmission node to be within a preset synchronization range. In this way, synchronization of the scheduling cycles for packet queue scheduling in the first transmission node and the second transmission node is macroscopically achieved, ensuring the deterministic network application scenarios with higher jitter accuracy requirement.

Furthermore, in the scheduling cycle synchronization method of the first transmission node and the second transmission node according to the present embodiment, no longer depending on strict clock synchronization of the transmission nodes at both ends, it is simply required to adjust a width of a scheduling cycle for packet queue scheduling in the transmission node at one end, to enable the error between the adjusted width of the scheduling cycle and a width of a scheduling cycle for packet queue scheduling in the other transmission node to be within a preset synchronization range, so as to achieve weak synchronization of the transmission nodes at both ends in deterministic flow transmission, ensuring normal forwarding of the deterministic flow.

The method provided by the embodiments of the present disclosure will be described below from the aspect of the second transmission node.

FIG. 2 is a flowchart illustrating another method according to embodiments of the present disclosure. The method is applied to the above second transmission node.

As shown in FIG. 2, the flow can include the following blocks.

At block 201, a first cycle synchronization information packet is received from the first transmission node at a time point t2[1] under the second clock domain and a current cycle of the second transmission node is determined.

In this embodiment, the current cycle of the second transmission node is denoted as C2_1.

As an embodiment, the current cycle of the second transmission node is a scheduling cycle (for packet queue scheduling) in which the second transmission node is currently located. For example, if the second transmission node is just in the M-th scheduling cycle at the time point t2[1], the current cycle C2_1 of the second transmission node at this time can be M.

As another embodiment, the current cycle of the second transmission node also be a system cycle in the second transmission node. For example, if the second transmission node is just in the M-th scheduling cycle at the time point t2[1], the system cycle recorded in the second transmission node at this time is 2M, and the above C2_1 can be 2M.

At block 202, based on a cycle C1_1 and first time information included in the first cycle synchronization information packet, a cycle in which the first transmission node is currently located at the time point t2[1] is determined.

In this embodiment, the cycle in which the first transmission node is currently located at the time point t2[1] is denoted as C1_2.

As an embodiment, for the convenience of determining C1_2, second time information can be introduced. The second time information is a time point under the third clock domain, which is determined based on time information under the third clock domain corresponding to the time point t2[1] in the second clock domain. Since the first time information and the second time information are under a same third clock domain, for example, 5GS clock domain, the cycle of the first transmission node corresponding to the time point t2[1] can be easily determined based on a time difference between the first time information and the second time information.

As an embodiment, determining the cycle in which the first transmission node is currently located at the time point t2[1] in the block 202 can be performed through blocks 1a to a3.

At block a1, a time difference between the first time information and the second time information is calculated.

The second time information is determined in a similar way to that of determining the above first time information, that is, determined, based on the time information which is under the third clock domain and corresponds to the time point t2[1]. Herein, the time information under the third clock domain corresponding to the time point t2[1] is denoted as t3[2].

For example, the first time information is time information t3[1] under the third clock domain corresponding to the time point t1[1] in the first clock domain, and correspondingly, the second time information is time information t3[2] under the third clock domain corresponding to the time point t2[1] in the second clock domain.

For another example, the first time information is a difference between t3[1] and the above t1_{CyclePast}, and correspondingly, the second time information is a difference between the t3[2] and t2_{CyelePast}, where t2_{CyclePast} is a difference between the time point t2[1] and a start moment of the scheduling cycle (for example, the above M-th scheduling cycle) corresponding to C1_2.

As an embodiment, t3[2] is determined in a similar way to the above t3[1]. For example, t3[2] can be expressed in the following formula (2):

$$t 3 [ 2 ] = t3\_ 2 [ 0 ] + b + Δ t 2 \qquad ( 2 )$$

In the formula (2), t3_2[0] represents time information under the third clock domain obtained by the second transmission node at a time point t2[0] under the second clock domain, and in other words, the time information is sent at t3_2[0] under the third clock domain and obtained by the second transmission node at t2[0]. As an embodiment, in the formula (2), t32[0] represents a time point under the third clock domain. Taking the third clock domain as 5GS clock domain in the 5GS as an example, t3_2[0] can be a time point under the 5GS clock domain in the 5GS. t3_2[0] is less than t3[2].

In the formula (2), b represents a transmission delay of time information between the second transmission node and the second intermediate device, and Δt2 represents a time difference between the time point t2[0] and the time point t2[1].

As mentioned above, the second time information is determined in a similar way to that of determining the first time information. Both of them are under the third clock domain, e.g., 5GS clock domain, and the time difference can be calculated directly based on the first time information and the second time information.

At block a2, based on the time difference and a time length of the scheduling cycle of the first transmission node, a cycle number of the scheduling cycles of the first transmission node corresponding to the time difference is determined.

In this embodiment, a quotient of the above time difference and the time length of the scheduling cycle of the first transmission node can be calculated and then based on the quotient, the above cycle number can be determined. For example, a positive integer closest to the quotient is determined as the above cycle number.

In this embodiment, due to synchronization, the above time length is not a fixed value but has little change and thus the accumulated error has little impact on the calculation. Therefore, it is equivalent to a constant value.

At block a3, based on the above cycle number and the C11, the cycle (denoted as C1_2) in which the first transmission node is currently located at the time point t2[1] is determined.

As an embodiment, the above C1_2 can represent a scheduling cycle in which the first transmission node is currently located for packet queue scheduling at the above time point t2[1]. Thus, if the above C1_1 also represents the scheduling cycle of the first transmission node, in this block a3, C1_2 represents a sum of the above C1_1 and the above cycle number. For example, if the above C1_1 is L (indicating the L-th scheduling cycle of the first transmission node), and the above cycle number is 10, the above C1_2 is L+10, which indicates the (L+10)-th scheduling cycle of the first transmission node.

The specific implementation of the block 202 is exemplified by the blocks a1 to a3 but not limited to the blocks.

At block 203, based on the C2_1 and C1_2, and C2_0 and C1_0 both determined by the second transmission node upon receiving a second cycle synchronization information packet previously, whether to adjust a width of a scheduling cycle of the second transmission node is determined; if yes, the width of the scheduling cycle of the second transmission node is adjusted to enable the an error between the adjusted width of the scheduling cycle and a width of a scheduling cycle for packet queue scheduling in the first transmission node to be within a preset synchronization range, where C2_0 represents a current cycle in which the second transmission node receives the second cycle synchronization information packet, and C1_0 represents a cycle in which the first transmission node is currently located when the second transmission node receives the second cycle synchronization information packet.

In this embodiment, if C2_1 represents a scheduling cycle in which the second transmission node is currently located when receiving the first cycle synchronization information packet, and correspondingly, C2_0 represents a scheduling cycle in which the second transmission node is currently located when receiving the second cycle synchronization information packet. Similarly, if C2_1 represents a system cycle in which the second transmission node is currently located when receiving the first cycle synchronization information packet, and correspondingly, C2_0 represents a system cycle in which the second transmission node is currently located when receiving the second cycle synchronization information packet.

In this embodiment, if the above C1_2 represents a scheduling cycle in which the first transmission node is currently located for packet queue scheduling at the time point t2[1], and correspondingly, the C1_0 represents a scheduling cycle in which the first transmission node is currently located when the second transmission node receives the second cycle synchronization information packet. Similarly, if the above C1_2 represents a system cycle in which the first transmission node is currently located at the time point t2[1], and correspondingly, the above C1_0 represents a system cycle in which the first transmission node is currently located when the second transmission node receives the second cycle synchronization information packet.

As an embodiment, determining whether to adjust the width of the scheduling cycle of the second transmission node based on C2_1 and C1_2 can be achieved in many ways, for example, by the following blocks b1 to b3.

At block b1, a first increment between C2_1 and C2_0 is calculated.

As an embodiment, the first increment can be a difference between C2_1 and C2_0.

Certainly, if there is no reception record of the second cycle synchronization information packet at current, the current flow can be directly ended.

At block b2, a second increment between C1_2 and C1_0 is calculated.

As an embodiment, the second increment can be a difference between C1_2 and C1_0.

At block b3, whether a difference between the first increment and the second increment is within a preset value range is determined. If the difference between the first increment and the second increment is not within the preset value range, it is determined to adjust the width of the scheduling cycle of the second transmission node; and if the difference between the first increment and the second increment is within the preset value range, it is determined not to adjust the width of the scheduling cycle of the second transmission node.

In this embodiment, the preset value range can be set based on actual requirements, which is not limited herein.

Furthermore, in this embodiment, adjusting the width of the scheduling cycle of the second transmission node can also be adjusting the time length of the scheduling cycle of the second transmission node, for example, increasing the time length of the scheduling cycle of the second transmission node or reducing the time length of the scheduling cycle of the second transmission node or the like. Whether to increase or reduce mainly depends on the difference between the first increment and the second increment, which is not limited herein. However, no matter what adjustment is made, the final object is to ensure synchronization of the scheduling cycles of the first transmission node and the second transmission node at a macro level.

It is to be noted that in this embodiment, in order to ensure accuracy, when the time length of the scheduling cycle of the second transmission node is adjusted, an adjustment step length can be defined such that synchronization of the scheduling cycles of the first transmission node and the second transmission node is finally achieved macroscopically in a gradual adjustment manner.

It is further to be noted that in this embodiment, when it is determined to adjust the scheduling cycle of the second transmission node, a previous record (for example, the above C2_0 and C1_0 and the like) of receiving the second cycle synchronization information packet can be directly deleted.

Here, the flow shown in FIG. 2 is completed.

It can be seen from the flow shown in FIG. 2 that, in this embodiment, the transmission nodes at both ends take the time information under the third clock domain, for example, the 5GS clock domain as reference, the first transmission node sends the first cycle synchronization information packet including at least the above cycle identifier C1_1 (for identifying the current deterministic flow scheduling cycle of the first transmission node) and the first time information, such that the second transmission node determines whether to adjust the scheduling cycle of the second transmission node based on the first cycle synchronization information packet, and when determining to adjust the scheduling cycle of the second transmission node, adjusts the scheduling cycle of the second transmission node, so as to enable an error between the adjusted scheduling cycle and the scheduling cycle of the first transmission node to be within a preset range. In this way, synchronization for the scheduling cycles of the first transmission node and the second transmission node is macroscopically achieved, ensuring the deterministic network application scenarios with higher jitter accuracy requirement.

Furthermore, based on the implementation of synchronization of the scheduling cycles of the first transmission node and the second transmission node, it can be seen that in this embodiment, without depending on strict clock synchronization of the transmission nodes at both ends, it is simply required to adjust a width of a scheduling cycle for packet queue scheduling in the transmission node at one end to enable the error between the adjusted width of the scheduling cycle and a width of a scheduling cycle for packet queue scheduling in the other transmission node to be within a preset synchronization range, so as to achieve weak synchronization of the transmission nodes at both ends in deterministic flow transmission, ensuring normal forwarding of the deterministic flow and ensuring that the clock domains of the transmission nodes at both ends are maintained independent of each other.

With the transmission nodes at both ends of the 5GS, the above method provided by the embodiments of the present disclosure is exemplified below.

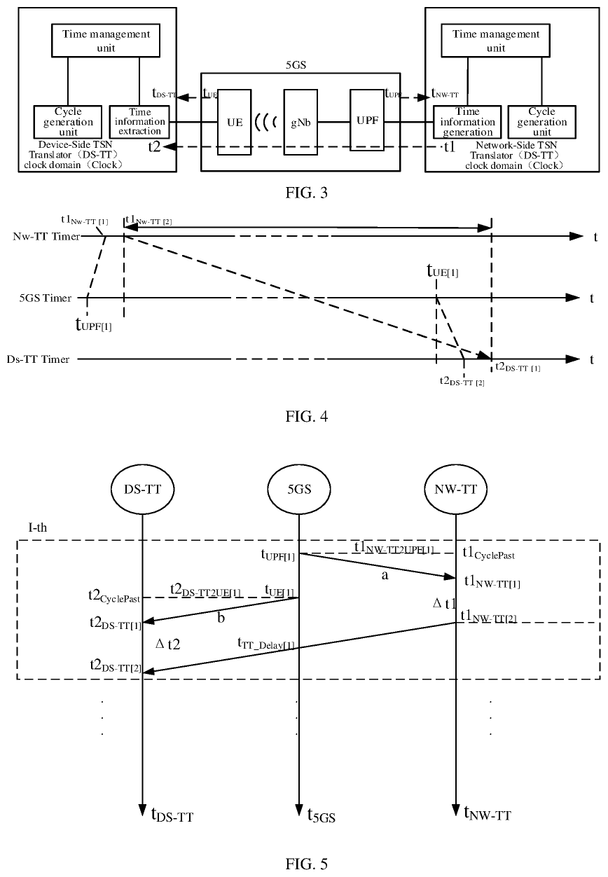

Applied to the network shown in FIG. 3, the NW-TT is coupled to the UPF through a channel between the UPF in the 5GS and the NW-TT. The channel herein is, for example, an Ethernet connection or an internal connection, which depends on whether the NW-TT and the UPF are integrated in one device or implemented separately, which is not limited herein.

In the network shown in FIG. 3, the DS-TT is coupled to the UE in the 5GS through 1PPS (One Pulse Per Second) and TOD (Time of Day) time information channel. FIG. 4 illustrates a clock domain (timer) relationship of NW-TT, 5GS and DS-TT. The 5GS has a unified clock domain (denoted as 5GS clock domain), and the times of the UPF and UE are synchronized in the 5GS clock domain.

If the first transmission node is the NW-TT and the second transmission node is the DS-TT, then,
as shown in the time sequence in FIG. 5, the NW-TT firstly obtains current time information t_{UPF[1]} of the UPF under the 5GS clock domain (e.g., the above t3_1[0]) through a channel (e.g., through an Ethernet connection or an internal connection) between the UPF in the 5GS and the NW-TT, with the transmission delay of obtaining the time information t_{UPF[1]} being a. At this time, the timing on the NW-TT is t1_{NW-TT[1]} (i.e., the above t1[0]). A mapping relationship between t1_{NW-TT[1]} and t_{UPF[1]} is t1_{NW-TT[1]}=t_{UPF[1]}+a. In this embodiment, the transmission delay a is fixed and small, and can be regarded as a constant value.

The NW-TT sends the first cycle synchronization information packet to the DS-TT at t1_{NW-TT[2]} (i.e., the above t1[1]). The first cycle synchronization information packet includes C1_1 and t1_{NW-TT2UPF[1]} (i.e., the first time information mentioned above).

In this embodiment, C1_1 represents a cycle in which the NW-TT is currently located at t1_{NW-TT[2]}. For example, C1_1 is a second scheduling cycle in which the NW-TT is currently located for packet queue scheduling at t1_{NW-TT[2]}, where C1_1 is 2; for another example, C1_1 represents a 20th system cycle in which the NW-TT is currently located at t1_{NW-TT[2]}, where C1_1 is 20.

As an embodiment, t1_{NW-TT2UPF[1]} can be expressed in the following formula (3):

$$t {1}_{NW - TT 2 UPF [ 1 ]} = {t}_{UPF [ 1 ]} + a + Δ t 1 - t {1}_{CyclePast} \qquad ( 3 )$$

In the formula (3), t1_{CyclePast} represents a difference between the time point t1_{NW-TT[2]} and a start moment of the cycle represented by the C1_1.

In the formula (3), Δt1 represents a time difference between the time point t1_{NW-TT[2]} and the time point t1_{NW-TT[1]}, where the time difference herein can include a delay from the time point t1_{NW-TT[1]} to the time point t1_{NW-TT[2]} (also including constructing the first cycle synchronization information packet and internally processing the first cycle synchronization information packet and the like). In a specific implementation, Δt1 is small, and in such a small time, the accumulated clock error resulting from the timing by the NW-TT and 5GS respectively can be neglected. Therefore, Δt1 is a timing in the clock domain of the NW-TT and can also be approximated as the timing of the 5GS clock domain.

The DS-TT receives the first cycle synchronization information packet from the NW-TT at t2_{DS-TT[1]} (i.e., the above t2[1]). At this time, the cycle in which the DS-TT is currently located at t2_{DS-TT[1]} represents C2_1. In an example, C2_1 can represent a scheduling cycle in which the DS-TT is currently located for packet queue scheduling at t2_{DS-TT[1]}. For example, if the DS-TT is currently in the second scheduling cycle at t2_{DS-TT[1]}, the C2_1 can be 2. In another example, the C2_1 can be a system cycle in which the DS-TT is currently located at t2_{DS-TT[1]}. For example, if the DS-TT is currently in the 20th system cycle at t2_{DS-TT[1]}, the C2_1 can be 20.

In this embodiment, if the DS-TT is prior to the time point t2_{DS-TT[1]}, for example, at the time point t_{2DS-TT[2]} (i.e., the above t3_2[0]), the time information t_{UE[1]} of the UE can be accurately obtained through the 1PPS and TOD time information channel between the DS-TT and the UE. At this time, the mapping relationship between the time point t_{2DS-TT[2]} and the t_{UE[1]} under the 5GS clock domain is t_{2DS-TT[2]}-t_{UE[1]}+b, where b represents the transmission delay of obtaining the t_{UE[1]} by the DS-TT (i.e., the transmission delay between the DS-TT and the UE).

In this embodiment, the time information corresponding to the time point t2_{DS-TT[1]} under the 5GS clock domain (i.e., the above t3[2]) can be approximated as t_{UE[1]}+b+Δt2. Δt2 is timed by the clock domain of the DS-TT, but it is very small and thus the influence generated by frequency offset can be neglected. Δt2 represents a difference between t2_{DS-TT[1]} and t2_{DS-TT[2]}.

Next, similar to the calculation of t1_{NW-TT2UPF[1]}, t2_{DS-TT2UE[1]} (i.e., the above second time information) can also be calculated in this embodiment. In this embodiment, t2_{DS-TT2UE[1]} can be expressed in the following formula (4).

$$t {2}_{DS - TT 2 UE [ 1 ]} = {t}_{UE [ 1 ]} + b + Δ t 2 - t {2}_{CyclePast} \qquad ( 4 )$$

In the formula (4), t2_{CyclePast} represents a difference between the time point t2_{DS-TT[1]} and a start moment of the cycle represented by the C2_1.

In this embodiment, the DS-TT extracts t1_{NW-TT2UPF[1]} and C1_1 from the received first cycle synchronization information packet.

Next, the cycle C1_2 in which the NW-TT is currently located at the time point t2_{DS-TT[1]} can be calculated based on the extracted t1_{NW-TT2UPF[1]} and the above t2_{DS-TT2UE[1]}. For example, a time difference t_{TT_Delay[1]} between t2_{DS-TT2UE[1]} and t1_{NW-TT2UPF[1]} can be firstly calculated. Because the UE and the UPF have the unified clock domain, t2_{DS-TT2UE[1]} and t1_{NW-TT2UPF[1]} can be directly calculated. The calculated time differenced is approximate to the delay of transmission and processing in the 5GS. Next, based on the time difference t_{TT_Delay[1]} and the time length t_{NW-TTCyleLen[1]} of the scheduling cycle of the NW-TT, the cycle number C_{TT_Delay[1]} of the scheduling cycles of the NW-TT corresponding to the time difference is calculated. C_{TT_Delay[1]} can be expressed in the following formula: C_{TT_Delay[1]}

$${C}_{TT \_ Delay [ 1 ]} = \frac{{t}_{TT \_ Delay [ 1 ]}}{{t}_{NW - TTCycleLen [ 1 ]}} .$$

In this embodiment, t_{NW-TTCyleLen[1]} changes little and hence, the accumulated error resulting from the changes has little impact on the calculation. Therefore, t_{NW-TTCyleLen[1]} can be equivalent to a constant value. Finally, based on the above cycle number C_{TT_Delay[1]} and the above C1_1, the cycle C1_2 in which the NW-TT is currently located at the time point t2_{DS-TT[1]} is determined.

In this embodiment, C1_1 represents a scheduling cycle in which the NW-TT is currently located at t1_{NW-TT[2]}, and C1_2 represents a scheduling cycle in which the NW-TT is currently located at t2_{DS-TT[1]}. C1_2 can be expressed in the following formula (5):

$$C1\_ 2 = C1\_ 1 + {C}_{TT \_ Delay [ 1 ]} \qquad ( 5 )$$

Here, the following record is finally obtained: the scheduling cycle C2_1 in which the DS-TT is located currently at the time point t2_{DS-TT[1]}, and the scheduling cycle C1_2 in which the NW-TT is currently located at the time point t2_{DS-TT[1]}. For ease of descriptions, this record herein is denoted as an I-th record.

It is supposed that there is also a J-th record (obtained in similar way) before the I-th record. The J-th record includes the following contents: the scheduling cycle C2_0 in which the DS-TT is currently located upon receiving the second cycle synchronization information packet, and the scheduling cycle C1_0 in which the NW-TT is currently located when the DS-TT receives the second cycle synchronization information packet.

Based on this, the respective cycle increments ΔC_{DS-TT} (i.e., the above first increment) of the DS-TT and ΔC_{NW-TT} (i.e., the above second increment) of the NW-TT are calculated.

$$Δ {C}_{DS - TT} = C2\_ 1 - C2\_ 0 ; \\ Δ {C}_{NW - TT} = C1\_ 2 - C1\_ 0.$$

It is determined whether a difference between ΔC_{DS-TT} and ΔC_{NW-TT} is within a preset value range; and if not, the scheduling cycle of the DS-TT is adjusted.

For example, if ΔC_{DS-TT} is greater than ΔC_{NW-TT}, the time length of the scheduling cycle of the DS-TT is increased (the specific increase amount depends on the difference between ΔC_{DS-TT} and ΔC_{NW-TT} if ΔC_{DS-TT} is less than ΔC_{NW-TT}, the time length of the scheduling cycle of the DS-TT is reduced (the specific reduction amount depends on the difference between ΔC_{DS-TT} and ΔC_{NW-TT}).

Afterwards, the DS-TT can schedule a packet in the packet queue for forwarding, based on the adjusted scheduling cycle.

Here, the descriptions to the embodiments of the present disclosure have been completed.

The above descriptions are made on the methods provided by the embodiments of the present disclosure. The following descriptions are made on a system and an apparatus provided by the embodiments of the present disclosure.

An embodiment provides a cycle synchronization system, which includes a first transmission node and a second transmission node. The first transmission node performs the blocks in the flow shown in FIG. 1 and the second transmission node performs the blocks in the flow shown in FIG. 2.

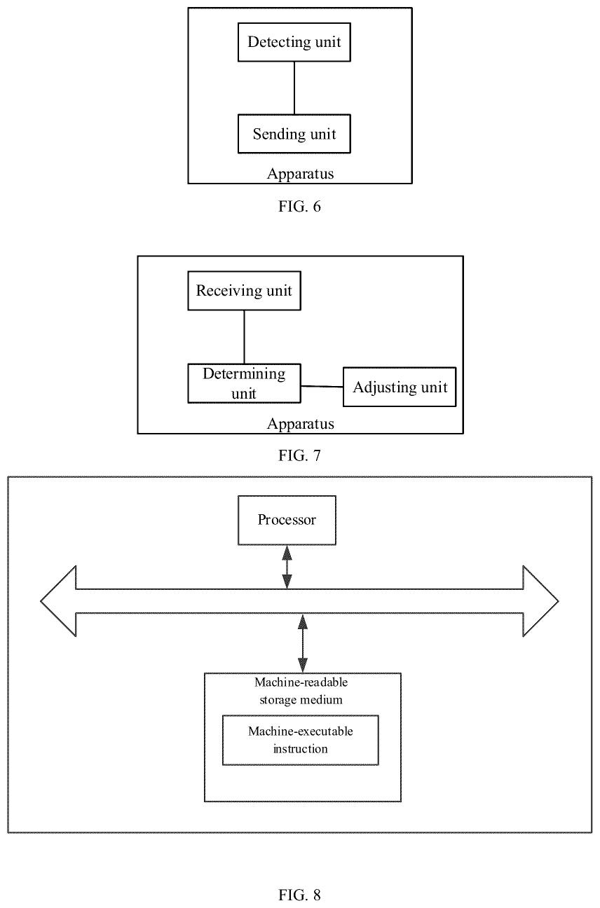

Correspondingly, an embodiment of the present disclosure further provides an apparatus shown in FIG. 6. The apparatus is applied to a first transmission node. The apparatus corresponds to the flow as shown in FIG. 1.

As shown in FIG. 6, the apparatus includes:
a detecting unit, configured to detect a packet transmission event;
a sending unit, configured to, when the detecting unit detects the packet transmission event, send a first cycle synchronization information packet to a second transmission node at a time point t1[1] under a first clock domain, such that the second transmission node, upon determining that a width of a scheduling cycle for packet queue scheduling in the second transmission node needs to be adjusted based on the first cycle synchronization information packet, adjusts the width of the scheduling cycle, so as to enable an error between the adjusted width of the scheduling cycle and a width of a scheduling cycle for packet queue scheduling in the first transmission node to be within a preset synchronization range;
the first cycle synchronization information packet includes at least: a current cycle C1_1 of the first transmission node and first time information; where the current cycle is a scheduling cycle in which the first transmission node is currently located for packet queue scheduling, or the current cycle is a system cycle of the first transmission node; the first time information is a time point under a third clock domain, which is determined based on time information t3[1] under the third clock domain corresponding to the time point t1[1] in the first clock domain.

As an embodiment, t3[1] can be expressed in the following formula:

$$t 3 [ 1 ] = t 3 [ 0 ] + a + Δt1 ;$$

where t3_1[0] represents time information under the third clock domain obtained by the first transmission node at a time point t[0] under the first clock domain, where the time point t1[0] is prior to the time point t1[1]; a represents a transmission delay of time information between the first transmission node and a first intermediate device, and Δt1 represents a time difference between the time point t1[1] and the time point t1[0].

As an embodiment, the first time information is time information t3[1] under the third clock domain corresponding to the time point t1[1] in the first clock domain; or,
the first time information is a difference between t3[1] and t1_{CyclePast}, where t1_{CyclePast} represents a difference between the time point t1[1] and a start moment of the current cycle.

As an embodiment, the packet transmission event includes at least arrival of packet transmission time or an externally-transmitted instruction.

As an embodiment, the network system is a 5G system (5GS);
the first transmission node is a Network-Side TSN Translator (NW-TT), the first intermediate device is a User Plane Function network element (UPF), the second transmission node is a Device-Side TSN Translator (DS-TT), and the second intermediate device is a terminal User Equipment (UE); or, the first transmission node is a DS-TT, the first intermediate device is a UE, the second transmission node is a NW-TT, and the second intermediate device is a UPF; or,
the first transmission node and the second transmission node are two different DS-TTs, and the first intermediate device and the second intermediate device are two different UEs.

Here, the structural descriptions on the apparatus shown in FIG. 6 are completed.

An embodiment of the present disclosure further provides an apparatus shown in FIG. 7. The apparatus corresponds to the flow in FIG. 2. The apparatus is applied to a second transmission node. As shown in FIG. 7, the apparatus includes:
a receiving unit, configured to receive a first cycle synchronization information packet from a first transmission node at a time point t2[1] under a second clock domain and determine a current cycle C2_1 of the second transmission node;
a determining unit, configured to, based on a cycle C1_1 and first time information included in the first cycle synchronization information packet, determine a cycle C1_2 in which the first transmission node is currently located at the time point t2[1];
an adjusting unit, configured to, based on the C2_1 and C1_2, and C2_0 and C1_0 both determined by the second transmission node upon receiving a second cycle synchronization information packet previously, determine whether to adjust a width of a scheduling cycle for packet queue scheduling in the second transmission node; if yes, adjust the width of the scheduling cycle for packet queue scheduling in the second transmission node to enable an error between the adjusted width of the scheduling cycle and a width of a scheduling cycle for packet queue scheduling in the first transmission node to be within a preset synchronization range, where C2_0 represents a current cycle in which the second transmission node receives the second cycle synchronization information packet, and C1_0 represents a cycle in which the first transmission node is located when the second transmission node receives the second cycle synchronization information packet.

As an embodiment, based on the cycle C1_1 and the first time information included in the first cycle synchronization information packet, determining, by the determining unit, the cycle C1_2 in which the first transmission node is currently located at the time point t2[1] includes:
calculating a time difference between second time information and the first time information; where the second time information is a time point under the third clock domain, which is determined based on time information t3[2] under the third clock domain corresponding to the time point t2[1] in the second clock domain;
based on the time difference and a time length of the scheduling cycle of the first transmission node, determining a cycle number of the scheduling cycles of the first transmission node corresponding to the time difference;
based on the cycle number and the C11, determining the cycle C1_2 in which the first transmission node is located at the time point t2[1].

As an embodiment, t3[2] is expressed in the following formula: t3[2]=t3_2[0]+b+Δt2;
where t32[0] represents time information under the third clock domain obtained by the second transmission node at a time point t2[0] under the second clock domain, where the time point t2[0] is prior to the time point t2[1]; b represents a transmission delay of time information between the second transmission node and a second intermediate device, and Δt2 represents a time difference between the time point t2[1] and the time point t2[0].

As an embodiment, the second time information is t3[2]; or,
the second time information is a difference between t3[2] and t2_{CyclePast}, where t2_{CyclePast} is a difference between the time point t2[1] and a start moment of a cycle represented by C2_1.

As an embodiment, based on the C2_1 and C1_2, and C2_0 and C1_0 both determined by the second transmission node upon receiving the second cycle synchronization information packet previously, determining, by the adjusting unit, whether to adjust the width of the scheduling cycle for packet queue scheduling in the second transmission node includes:
calculating a first increment between C2_1 and C2_0;
calculating a second increment between C1_2 and C1_0;
determining whether a difference between the first increment and the second increment is within a preset value range; if not, determining to adjust the width of the scheduling cycle of the second transmission node; if yes, determining not to adjust the width of the scheduling cycle of the second transmission node.

As an embodiment, the network system is a 5G system (5GS);
the first transmission node is a Network-Side TSN Translator (NW-TT), the first intermediate device is a User Plane Function network element (UPF), the second transmission node is a Device-Side TSN Translator (DS-TT), the second intermediate device is a terminal User Equipment (UE); or the first transmission node is a DS-TT, the first intermediate device is a UE, the second transmission node is a NW-TT, and the second intermediate device is a UPF; or,
the first transmission node and the second transmission node are two different DS-TTs, and the first intermediate device and the second intermediate device are two different UEs.

Here, the structural descriptions on the apparatus shown in FIG. 7 are completed.

FIG. 8 is a structural diagram illustrating an electronic device according to an embodiment of the present disclosure. As shown in FIG. 8, the hardware structure can include: a processor and a machine-readable storage medium, where the machine-readable storage medium stores machine executable instructions executable by the processor; and the processor is configured to execute the machine executable instructions to perform the methods mentioned in the above embodiments of the present disclosure.

Based on the same application idea as the above methods, an embodiment of the present disclosure further provides a machine-readable storage medium storing several computer instructions, where the computer instructions are executed by a processor to perform the methods mentioned in the above embodiments of the present disclosure.

Illustratively, the machine-readable storage medium mentioned herein may be any of electronic, magnetic, optical or other physical storage devices and may contain or store information such as executable instructions, data and so on. For example, the machine-readable storage medium may be a Random Access Memory (RAM), volatile or non-volatile memory, a flash memory, a storage drive (e.g. hard disk drive), a solid state harddisk, any type of storage disk (e.g., compact disk, Digital Video Disk (DVD)), or a similar storage medium, or a combination thereof.

The systems, apparatuses, modules or units described in the above embodiments may be specifically implemented by a computer chip or an entity or may be implemented by a product with a particular function. A typical implementing device may be a computer and the computer may be specifically a personal computer, a laptop computer, a cellular phone, a camera phone, a smart phone, a personal digital assistant, a media player, a navigation device, an email transceiver, a game console, a tablet computer, a wearable device, or a combination of any several devices of the above devices.

For convenience of description, the above apparatus is divided into different units based on functionality for descriptions. Of course, the functions of different units may be implemented in a same or a plurality of hardware and/or software when practicing the present disclosure.

The persons skilled in the art should understand that the embodiments of the present disclosure may be provided as a method, a system, or a computer program product. Thus, entire hardware embodiments, entire software embodiments or embodiments combining software and hardware may be adopted in the present disclosure. Further, the present disclosure may be implemented in the form of a computer program product that is operated on one or more computer available storage media (including but not limited to magnetic disk memory, CD-ROM, and optical memory and so on) including computer available program codes.

The present disclosure is described by referring to flowcharts and/or block diagrams of a method, a device (a system) and a computer program product in the embodiments of the present disclosure. It is understood that each flowchart and/or block in the flowcharts and/or the block diagrams or a combination of a flow chart and/or a block of the flowcharts and/or the block diagrams may be implemented by computer program instructions. These computer program instructions may be provided to a general-purpose computer, a dedicated computer, an embedded processor, or a processor of another programmable data processing device to generate a machine so that the instructions executable by a computer or a processor of another programmable data processing device generate an apparatus for implementing functions designated in one or more flows of the flowcharts and/or one or more blocks of the block diagrams.

Further, these computer program instructions may also be stored in a computer readable memory that can direct a computer or another programmable data processing device to work in a particular manner so that the instructions stored in the computer readable memory generate a product including an instruction apparatus and the instruction apparatus can implement functions designated in one or more flows of the flowcharts and/or one or more blocks of the block diagrams.

The computer program instructions may also be loaded on a computer or another programmable data processing device, so that a series of operation steps can be executed on the computer or another programmable device to generate processing achieved by the computer, and thus instructions executable on the computer or another programmable device are provided for operations for realizing functions designated in one or more flows of the flowcharts and/or one or more blocks of the block diagrams.

The above descriptions are only some embodiments of the present disclosure, and are not used to limit the present disclosure. For those skilled in the art, the present disclosure may have various changes and modifications. Any modifications, equivalent replacements, improvements, etc. made in the spirit and principle of this present disclosure shall fall within the scope of claims of the present disclosure.

1. A cycle synchronization method, applied to a first transmission node, wherein the first transmission node is coupled to a second transmission node, a first clock domain of the first transmission node is different from a second clock domain of the second transmission node, a network system between the first transmission node and the second transmission node is coupled to the first transmission node through a first intermediate device and is coupled to the second transmission node through a second intermediate device, the first intermediate device and the second intermediate device have a same third clock domain in the network system; the method comprises:
in response to detecting a packet transmission event, sending a first cycle synchronization information packet to the second transmission node at a time point t1[1] under the first clock domain, such that the second transmission node, upon determining that a width of a scheduling cycle for packet queue scheduling in the second transmission node needs to be adjusted based on the first cycle synchronization information packet, adjusts the width of the scheduling cycle, so as to enable an error between the adjusted width of the scheduling cycle and a width of a scheduling cycle for packet queue scheduling in the first transmission node to be within a preset synchronization range;
the first cycle synchronization information packet comprises at least: a current cycle C1_1 of the first transmission node and first time information; wherein the current cycle is a scheduling cycle in which the first transmission node is currently located for packet queue scheduling, or the current cycle is a system cycle of the first transmission node; the first time information is a time point under the third clock domain, which is determined based on time information t3[1] under the third clock domain corresponding to the time point t1[1] in the first clock domain.

2. The method of claim 1, wherein t3[1] is expressed in the following formula:
$$t 3 [ 1 ] = t3\_ 1 [ 0 ] + a + Δt1 ;$$
wherein t3_1[0] represents time information under the third clock domain obtained by the first transmission node at a time point t1[0] under the first clock domain, wherein the time point t1[0] is prior to the time point t1[1]; a represents a transmission delay of time information between the first transmission node and the first intermediate device, and Δt1 represents a time difference between the time point t1[1] and the time point t1[0].

3. The method of claim 1, wherein the first time information is the time information t3[1] under the third clock domain corresponding to the time point t1[1] in the first clock domain; or,
the first time information is a difference between t3[1] and t1 CyclePast, wherein t1_{CyclePast} represents a difference between the time point t1[1] and a start moment of the current cycle.

4. The method of claim 1, wherein the packet transmission event comprises at least: arrival of packet transmission time or an externally-transmitted instruction.

5. The method of claim 1, wherein the network system is a 5G system (5GS);
the first transmission node is a Network-Side TSN Translator, NW-TT, the first intermediate device is a User Plane Function network element, UPF, the second transmission node is a Device-Side TSN Translator, DS-TT, and the second intermediate device is a terminal User Equipment, UE; or, the first transmission node is a DS-TT, the first intermediate device is a UE, the second transmission node is a NW-TT, and the second intermediate device is a UPF; or,
the first transmission node and the second transmission node are two different DS-TTs, and the first intermediate device and the second intermediate device are two different UEs.

6. A cycle synchronization method, applied to a second transmission node, wherein the second transmission node is coupled to a first transmission node, a first clock domain of the first transmission node is different from a second clock domain of the second transmission node, a network system between the first transmission node and the second transmission node is coupled to the first transmission node through a first intermediate device, and is coupled to the second transmission node through a second intermediate device, and the first intermediate device and the second intermediate device have a same third clock domain in the network system; the method comprises:
receiving a first cycle synchronization information packet from the first transmission node at a time point t2[1] under the second clock domain and determining a current cycle C2_1 of the second transmission node;
based on a cycle C1_1 and first time information comprised in the first cycle synchronization information packet, determining a cycle C1_2 in which the first transmission node is currently located at the time point t2[1];
based on the C2_1 and C1_2, and C2_0 and C1_0 both determined by the second transmission node upon receiving a second cycle synchronization information packet previously, determining whether to adjust a width of a scheduling cycle for packet queue scheduling in the second transmission node; if yes, adjusting the width of the scheduling cycle for packet queue scheduling in the second transmission node to enable an error between the adjusted width of the scheduling cycle and a width of a scheduling cycle for packet queue scheduling in the first transmission node to be within a preset synchronization range, wherein C2_0 represents a current cycle in which the second transmission node receives the second cycle synchronization information packet, and C1_0 represents a cycle in which the first transmission node is located when the second transmission node receives the second cycle synchronization information packet.

7. The method of claim 6, wherein based on the cycle C1_1 and the first time information comprised in the first cycle synchronization information packet, determining the cycle C1_2 in which the first transmission node is currently located at the time point t2[1] comprises:
calculating a time difference between second time information and the first time information; wherein the second time information is a time point under the third clock domain, which is determined based on time information t3[2] under the third clock domain corresponding to the time point t2[1] in the second clock domain;
based on the time difference and a time length of the scheduling cycle of the first transmission node, determining a cycle number of the scheduling cycles of the first transmission node corresponding to the time difference;
based on the cycle number and the C1_1, determining the cycle C1_2 in which the first transmission node is located at the time point t2[1].

8. The method of claim 7, wherein,
t3[2] is expressed in the following formula: t3[2]=t3_2[0]+b+Δt2;
wherein t3_2[0] represents time information under the third clock domain obtained by the second transmission node at a time point t2[0] under the second clock domain, wherein the time point t2[0] is prior to the time point t2[1]; b represents a transmission delay of time information between the second transmission node and the second intermediate device, and Δt2 represents a time difference between the time point t2[1] and the time point t2[0].

9. The method of claim 7, wherein the second time information is t3[2]; or,
the second time information is a difference between t3[2] and t2_{CyclePast}, wherein t2_{CyclePast} represents a difference between the time point t2[1] and a start moment of a cycle represented by C2_1.

10. The method of claim 6, wherein based on the C2_1 and C1_2, and C2_0 and C1_0 both determined by the second transmission node upon receiving the second cycle synchronization information packet previously, determining whether to adjust the width of the scheduling cycle for packet queue scheduling in the second transmission node comprises:
calculating a first increment between C2_1 and C2_0;
calculating a second increment between C1_2 and C1_0;
determining whether a difference between the first increment and the second increment is within a preset value range; if not, determining to adjust the width of the scheduling cycle of the second transmission node; if yes, determining not to adjust the width of the scheduling cycle of the second transmission node.

11. The method of claim 6, wherein the network system is a 5G system (5GS);
the first transmission node is a Network-Side TSN Translator, NW-TT, the first intermediate device is a User Plane Function network element, UPF, the second transmission node is a Device-Side TSN Translator, DS-TT, and the second intermediate device is a terminal User Equipment, UE; or, the first transmission node is a DS-TT, the first intermediate device is a UE, the second transmission node is a NW-TT, and the second intermediate device is a UPF; or,
the first transmission node and the second transmission node are two different DS-TTs, and the first intermediate device and the second intermediate device are two different UEs.

12. A cycle synchronization system, comprising: a first transmission node and a second transmission node, wherein a first clock domain of the first transmission node is different from a second clock domain of the second transmission node, a network system between the first transmission node and the second transmission node is coupled to the first transmission node through a first intermediate device, and is coupled to the second transmission node through a second intermediate device, the first intermediate device and the second intermediate device have a same third clock domain in the network system;
the first transmission node performs the operations according to the method of claim 1;
the second transmission node performs the operations according to a method comprising:
receiving a first cycle synchronization information packet from the first transmission node at a time point t2[1] under the second clock domain and determining a current cycle C2_1 of the second transmission node;
based on a cycle C1_1 and first time information comprised in the first cycle synchronization information packet, determining a cycle C1_2 in which the first transmission node is currently located at the time point t2[1];
based on the C2_1 and C1_2, and C2_0 and C1_0 both determined by the second transmission node upon receiving a second cycle synchronization information packet previously, determining whether to adjust a width of a scheduling cycle for packet queue scheduling in the second transmission node: if yes, adjusting the width of the scheduling cycle for packet queue scheduling in the second transmission node to enable an error between the adjusted width of the scheduling cycle and a width of a scheduling cycle for packet queue scheduling in the first transmission node to be within a preset synchronization range, wherein C2_0 represents a current cycle in which the second transmission node receives the second cycle synchronization information packet, and C1_0 represents a cycle in which the first transmission node is located when the second transmission node receives the second cycle synchronization information packet.

13-23. (canceled)

24. An electronic device, comprising a processor and a machine-readable storage medium; wherein,
the machine-readable storage medium stores machine executable instructions executable by the processor;
the processor is configured to execute the machine executable instructions to perform the method of claim 1.

25. A non-volatile machine-readable storage medium, storing machine executable instructions executable by a processor; wherein,
the machine executable instructions are executed by the processor to perform the method of claim 1.
